(19) United States
(12) Patent Application Publication
(10) Pub. No.: US 2021/0123110 A1
(43) Pub. Date: Apr. 29, 2021

(54) PLANT COMPLEX FOR PIG IRON PRODUCTION AND A METHOD FOR OPERATING THE PLANT COMPLEX

(71) Applicants: thyssenkrupp Industrial Solutions AG, Essen (DE); thyssenkrupp AG, Essen (DE)

(72) Inventor: Matthias KRÜGER, Herne (DE)

(73) Assignees: thyssenkrupp Industrial Solutions AG, Essen (DE); thyssenkrupp AG, Essen (DE)

(21) Appl. No.: 16/638,502

(22) PCT Filed: Sep. 29, 2017
(86) PCT No.: PCT/EP2017/074857

§ 371 Date: Feb. 12, 2020

(30) Foreign Application Priority Data
Aug. 23, 2017 (DE) 10 2017 214 772.5

(51) Int. Cl. C21B 7/00; C21B 5/06; C21B 13/00

(52) U.S. Cl. CPC C21B 7/002; C21B 2100/22; C21B 13/0073; C21B 5/06

(57) ABSTRACT

A plant complex for pig iron production may include a furnace and a furnace gas conduit system for a furnace gas quantity stream that comprises nitrogen, carbon monoxide, and carbon dioxide. The plant complex may also include a hydrogen source, an H₂ gas conduit system for a hydrogen-containing gas quantity stream emitted from the hydrogen source, a mixing apparatus for establishing a mixed gas formed from the furnace gas stream and the hydrogen-containing gas quantity stream. The mixing apparatus may be connected to the furnace gas conduit system and to the H₂ gas conduit system. The mixed gas established may have a stoichiometric mixing quotient formed from a dividend with a difference value between molar amounts of hydrogen as minuend and carbon dioxide as subtrahend and of a divisor with a sum value of molar amounts of carbon monoxide and carbon dioxide. The plant complex may also include a mixed gas conduit system and a chemical plant connected to the mixed gas conduit system.

The invention relates to a plant complex for pig iron production and to a method of operating the plant complex.

### PRIOR ART

Plant complexes for pig iron production are known in the prior art in a multitude of embodiments. For example, a plant complex comprises a furnace for pig iron production, a furnace gas conduit system for at least one furnace gas quantity stream obtained in the pig iron production, wherein the furnace gas quantity stream has a composition comprising at least carbon monoxide and/or carbon dioxide and especially nitrogen, a hydrogen source, an H₂ gas conduit system for at least one hydrogen-containing gas quantity stream emitted from the hydrogen source, wherein at least one mixing apparatus for establishing at least one mixed gas from the at least one furnace gas stream and the at least one hydrogen-containing gas quantity stream emitted from hydrogen source is provided, and a mixed gas conduit system for the at least one mixed gas and a chemical plant connected to the mixed gas conduit system.

With regard to the furnace for pig iron production, it is possible to distinguish, for example, between a blast furnace route and a melting furnace reduction route. In the blast furnace route, pig iron is obtained in the blast furnace from iron ores, admixtures and coke and other reducing agents such as coal, oil, gas, biomasses, processed used plastics or other carbon- and/or hydrogen-containing substances. Products inevitably formed in the reduction reactions are CO, CO₂, and especially hydrogen and water vapor. A blast furnace top gas are drawn off from the blast furnace process, which is also referred to as top gas and/or blast furnace gas, as well as the aforementioned constituents, frequently has a high nitrogen content and may also contain impurities. The amount of gas and the composition of the blast furnace top gas are dependent on the feedstocks and the mode of operation and are subject to variation. Typically, however, blast furnace top gas contains 35% to 60% by volume of N₂, 20% to 30% by volume of CO, 20% to 30% by volume of CO₂, and 2% to 15% by volume of H₂. Around 30% to 40% of the blast furnace top gas formed in pig iron production is generally used to heat up the hot blast for the blast furnace process in blast heaters; the remaining amount of top gas can also be utilized externally for heating purposes or for power production, for example in other parts of the works.

The plant complex with a blast furnace can optionally be operated in an integrated system with a coking plant. In this case, the plant complex described at the outset additionally comprises a coking furnace plant in which coal is converted to coke by a coking process. In the coking of coal to coke, a coking furnace gas is obtained, which contains a high hydrogen content and considerable amounts of CH₄. Typically, coking furnace gas contains 55% to 70% by volume of H₂, 20% to 30% by volume of CH₄, 5% to 10% by volume of N₂, and 5% to 10% by volume of CO. In addition, the coking furnace gas includes proportions of CO₂, NH₃ and H₂S. In practice, the coking furnace gas is utilized, for example, in various parts of the works for heating purposes and in the power plant process for power generation. Furthermore, it is known that coking furnace gas can be used together with blast furnace top gas or with converter gas for production of synthesis gases. By a process known from WO 2010/136313 A1, coking furnace gas is separated into a hydrogen-rich gas stream and a CH₄- and CO-containing tail gas stream, wherein the tail gas stream is sent to the blast furnace process and the hydrogen-rich gas stream is mixed with blast furnace top gas and processed further to give a synthesis gas. EP 0 200 880 A2 discloses mixing converter gas and coking furnace gas and utilizing the mixture as synthesis gas for a methanol synthesis.

In an integrated foundry being operated in conjunction with a coking plant, about 40% to 50% of the crude gases obtained as blast furnace top gas and coking furnace gas is used for industrial processes. About 50% to 60% of the gases formed are sent to the power plant and utilized for power generation. The power generated in the power plant covers the power demand for the pig iron and crude steel production and, for example, the operation of rolling mills and finishing plants as well. Ideally, the energy balance is closed, such that, apart from iron ores and carbon in the form of coal and coke as energy carrier, no further input of energy is needed and, apart from steel products and slag, essentially no further product leaves the plant complex.

The melting furnace reduction relates to methods in which ores are reduced in a two-stage process. In the first stage the ores are pre-reduced to iron sponge, and in the second stage the iron sponge is converted to pig iron using coal, optionally coke and oxygen. Known melting furnace reduction methods with a melt reduction furnace are, for example, the Corex process and the Finex process. The offgases formed in the melting furnace production method typically contain 10% to 20% by volume of H₂, 30% to 50% by volume of CO₂, 0% to 5% by volume of CH₄, 0% to 10% by volume of N₂, and 30% to 50% by volume of CO.

The direct reduction relates to methods in which merely the oxygen is removed from the ores, and the gangue constituents of the ores remain in what is called iron sponge. Known direct reduction methods with a direct reduction furnace are especially the Midrex or HYL direct production method, which produce DRI (Direct Reduced Iron) or HBI (Hot Briquetted Iron) iron sponge as a solid, pre-reduced starting material for downstream processes. This DRI or HBI is essentially melted in electrical light arc furnaces, used as scrap substitute in an oxygen steel converter or else, in the form of HBI, used in a blast furnace in some cases in order to reduce the demand for reducing agent therein and to increase performance. The reduction gas is generated in most direct reduction methods by converting natural gas to hydrogen and carbon monoxide.

Against this background, it is an object of the invention to further improve the economic viability of the overall process and to specify a very simplified, uncomplicated plant complex with a reduced number of plant components and/or process steps and few stages, in which furnace gas is provided for further processing in a chemical plant, especially for methanol synthesis. More particularly, the intention is to specify a plant complex with which it is possible to reduce the costs for pig iron production. For operation of the method, the intention is to utilize furnace gas obtained as a waste product in an industrial process. The method steps are to be chosen such that the gas components of the furnace gas are converted largely completely and with the proportions needed for the chemical plant.

### DISCLOSURE OF THE INVENTION

This object is achieved by a plant complex for pig iron production as claimed in claim 1 and by a method of operating a plant complex as claimed in claim 9.

The invention provides a plant complex comprising a furnace for pig iron production, a furnace gas conduit system for at least one furnace gas quantity stream obtained in the pig iron production, wherein the furnace gas quantity stream has a composition comprising at least carbon monoxide and carbon dioxide, a hydrogen source, an H₂ gas conduit system for at least one hydrogen-containing gas quantity stream emitted from the hydrogen source, wherein at least one mixing apparatus for establishing at least one mixed gas formed from the at least one furnace gas stream and the at least one hydrogen-containing gas quantity stream emitted from the hydrogen source is provided, wherein the at least one mixing apparatus is connected to the furnace gas conduit system and to the H₂ gas conduit system and wherein the at least one mixed gas established comprises at least a stoichiometric mixing quotient formed from a dividend with the difference value between the molar amounts of hydrogen as minuend and carbon dioxide as subtrahend and of a divisor with the sum value of the molar amounts of carbon monoxide and carbon dioxide, and a mixed gas conduit system for the at least one mixed gas which is obtained in the establishment of the at least one mixing quotient and has a chemical plant connected to the mixed gas conduit system.

The invention further provides a method of operating a plant complex comprising a furnace for pig iron production, a furnace gas conduit system for at least one furnace gas quantity stream obtained in the pig iron production, wherein the furnace gas quantity stream has a composition comprising at least carbon monoxide and carbon dioxide, a hydrogen source, an H₂ gas conduit system for at least one hydrogen-containing gas quantity stream emitted from the hydrogen source, wherein at least one mixing apparatus for establishing at least one mixed gas formed from the at least one furnace gas stream and the at least one hydrogen-containing gas quantity stream emitted from the hydrogen source is provided, wherein the at least one mixing apparatus is connected to the furnace gas conduit system and to the H₂ gas conduit system and wherein the at least one mixed gas established comprises at least a stoichiometric mixing quotient formed from a dividend with the difference value between the molar amounts of hydrogen as minuend and carbon dioxide as subtrahend and of a divisor with the sum value of the molar amounts of carbon monoxide and carbon dioxide, and a mixed gas conduit system for the at least one mixed gas which is obtained in the establishment of the at least one mixing quotient and has a chemical plant connected to the mixed gas conduit system, comprising the following steps:
a) providing the at least one furnace gas quantity stream;
b) providing the at least one hydrogen-containing gas quantity stream emitted from the hydrogen source;
c) producing at least one mixed gas by mixing the at least one furnace gas quantity stream provided in step a) with the at least one hydrogen-containing gas quantity stream provided in step b), wherein the at least a stoichiometric mixing quotient is formed is established with the dividend with the difference value between the molar amounts of hydrogen as minuend and carbon dioxide as subtrahend and the divisor with the sum value of the molar amounts of carbon monoxide and carbon dioxide;
d) feeding the at least one mixed gas produced in step c) through the mixed gas conduit system to the chemical plant connected to the mixed gas system.

The present invention may be implemented in a plant complex for pig iron production and a method of operating a plant complex. The apparatuses of the plant complex may be present singly and/or in duplicated form.

The plant complex of the invention for pig iron production has the advantage over conventional plant complexes that the furnace gas from the crude gases obtained in the pig iron production is utilizable especially with an H₂ source for supply to a chemical plant. Moreover, the plant complex, by comparison with conventional plant complexes, is of simpler and less complicated construction with fewer plant components and a reduced number of process steps. Furthermore, the plant complex has improved ability to influence the economic viability of the overall process. Moreover, the plant complex, especially with the option of dispensing with gas conditioning, is to entail low capital costs and operating complexity. Furthermore, the gas production is to be performable with low emissions and in an environmentally benign manner. Moreover, the plant complex of the invention together with the chemical plant has the advantage over conventional chemical plants that the feed gases used may be offgases from plant complexes for pig iron production, for example, which can influence economic viability and is more environmentally benign. Moreover, by contrast with conventional chemical plants, there is the option of dispensing with complex and emissions-intensive methods of gas production, for example steam reforming and gasification. Furthermore, it is possible through the use of “green” hydrogen sources to introduce renewable energy into the plant complex.

The method of the invention for operating a plant complex has the advantage over conventional methods that the furnace gas from the crude gases obtained in pig iron production is utilizable on its own for supply to a chemical plant. Moreover, the method has a reduced number of process steps compared to conventional methods. Furthermore, it is possible by a simple routes to incorporate renewable energy into the process and to save emissions of CO₂, for example, by comparison with the operating of conventional plant complexes. The method of the invention for operating a plant complex has the advantage over conventional methods that there is no need to use fossil energy carriers directly for gas production and, more particularly, furnace gas is sufficient.

### DETAILED DESCRIPTION OF THE INVENTION

In the context of the present invention, a furnace gas stream is understood to mean a gas stream that has been drawn off from the furnace process.

In the context of the present invention, a furnace gas conduit system is understood to mean a system composed of gas conduits that can be charged with gases obtained in the furnace, especially in pig iron production.

In the context of the present invention, a hydrogen source is understood to mean a source that provides hydrogen. A hydrogen source may be provided, for example, in a plant for hydrogen production, in a hydrogen gas-conducting gas conduit system, a pyrolysis plant, a steam reforming plant, a water-gas shift plant, a pressure swing adsorption (PSA) plant, especially a coking furnace gas pressure swing adsorption plant, a purge gas recycling system, for example within the plant complex, a hydrogen-containing offgas, especially from a chemical plant or refinery, or a combination of these. More particularly, the hydrogen can be produced by electrolysis, preferably by water electrolysis, wherein the water electrolysis is appropriately operated with electrical current that has been generated from renewable energy.

In the context of the present invention, an H₂ gas conduit system is understood to mean a system composed of at least one gas conduit that can be charged with hydrogen provided from a hydrogen source, especially obtained in water electrolysis, and or hydrogen-rich fluid or a combination of these.

In the context of the present invention, a mixing apparatus is understood to mean an apparatus with which a mixed gas comprising furnace gas and hydrogen and comprising at least a stoichiometric mixing quotient formed from a dividend with the difference value between the molar amounts of hydrogen as minuend and carbon dioxide as subtrahend and from a divisor with the sum value of the molar amounts of carbon monoxide and carbon dioxide is produced. More particularly, a mixing apparatus may be selected from a group of a Venturi nozzle, a mixing vessel, a mixing station, a static mixer, an ejector, a pipeline T-piece or a combination of these.

In the context of the present invention, a mixed gas conduit system is understood to mean a system composed of at least one gas conduit which can be charged with a mixed gas of the invention comprising furnace gas and hydrogen and/or hydrogen-rich fluid or a combination of these, wherein the mixed gas conduit system is in fluidic connection with the mixing apparatus and is disposed downstream of the mixing apparatus in flow direction.

In the context of the present invention, a chemical plant is understood to mean a plant with which organic compounds, especially hydrocarbon compounds and oxygenates thereof, for example methanol, can be provided. More particularly, it is possible to use a chemical plant of the invention to produce chemical products, for example methanol or else other hydrocarbon compounds, from a mixed gas comprising at least a stoichiometric mixing quotient formed from a dividend with the difference value between the molar amounts of hydrogen as minuend and carbon dioxide as subtrahend and from a divisor with the sum value of the molar amounts of carbon monoxide and carbon dioxide. The performance of the chemical plant is controlled as a function of the mixed gas volume supplied to these plants. A significant challenge for the chemical plant is the dynamic mode of operation at varying plant loads. The mode of operation at varying plant loads can especially be achieved in that the chemical plant has a multitude of small units connected in parallel that are individually switched on or off according to the quantity stream of useful gas available.

### Embodiments of the Invention

In a further embodiment of the invention, the composition of the furnace gas quantity stream additionally comprises nitrogen.

According to a further embodiment of the invention, the mixed gas established with the at least one mixing apparatus has a stoichiometric mixing quotient with the dividend with the difference value between the molar amounts of hydrogen as minuend and carbon dioxide as subtrahend and the divisor with the sum value of the molar amounts of carbon monoxide and carbon dioxide in the range from 1 to 10, preferably in the range from 1.2 to 6, more preferably in the range from 1.8 to 4, most preferably in the range from 1.9 to 3. More particularly, the calculation of the mixing quotient also includes CO or CO₂ equal to 0.

According to a further embodiment of the invention, the plant complex additionally comprises at least one plant for gas cleaning, wherein the at least one plant for gas cleaning is connected to the furnace gas conduit system and/or the H₂ gas conduit system and/or the mixed gas conduit system.

In the context of the present invention, a plant for gas cleaning is understood to mean a plant that at least partly separates of those components of a furnace gas that could have a disadvantageous effect, especially the efficiency in downstream process steps. More particularly, a gas cleaning operation is understood to mean a single- or multistage cleaning operation, especially selected from a group of mechanical sorting methods, for example a separation on the basis of density, particle size, particle inertia, surface wettability, magnetizability, electrical mobility or a combination of these, of chemical separating methods, for example a separation on the basis of chemical properties, for example catalytic methods, desulfurizing methods, methods of removing oxygen or a combination of these, of thermal separating methods, for example a separation on the basis of boiling point, freezing point, sublimation, solubility or a combination of these. In a two-stage cleaning operation, for example, the coarser dust particles are separated out in a first “dry” stage as top dust, especially with a vortexer, dust bag or a combination of these. The finer particles are usually removed “wet” in a second stage by injecting water, especially with a scrubber, annular gap scrubber or a combination of these. Examples of the removal of troublesome constituents are tar, sulfur and sulfur compounds, and dusts.

Advantageously, the chemical plant is put under a pressure in the range from 1 to 400 bar, preferably in the range from 20 to 200 bar, more preferably in the range from 50 to 130 bar, most preferably in the range from 60 to 80 bar.

In a further embodiment of the invention, the plant complex additionally comprises at least one plant for gas compression, wherein the at least one plant for gas compression is connected to the furnace gas conduit system and/or the H₂ gas conduit system and/or the mixed gas conduit system. Advantageously, the plant for gas compression provides a pressure in the range from 1 to 400 bar, preferably in the range from 20 to 200 bar, more preferably in the range from 50 to 130 bar, most preferably in the range from 60 to 80 bar. More particularly, a downstream chemical plant can be subjected to the aforementioned pressure ranges.

According to a further embodiment of the invention, the plant complex additionally comprises at least one plant for carbon monoxide separation and/or carbon dioxide separation, wherein the at least one plant for carbon monoxide separation and/or carbon dioxide separation is connected to the furnace gas conduit system and/or the H₂ gas conduit system and/or the mixed gas conduit system.

In the context of the present invention, a plant for carbon monoxide separation is understood to mean a plant that at least partly separates off carbon monoxide.

In the context of the present invention, a plant for carbon dioxide separation is understood to mean a plant that at least partly separates off carbon dioxide.

According to a further embodiment of the invention, the plant complex additionally comprises a further carbon dioxide source, wherein the at least one further carbon dioxide source is connected to the furnace gas conduit system and/or the H₂ gas conduit system and/or the mixed gas conduit system.

In the context of the present invention, a carbon dioxide source is understood to mean a source that provides carbon dioxide. A carbon dioxide source may comprise, for example, a carbon dioxide-containing quantity stream, especially fluid stream, obtained from a production plant with a carbon dioxide source. For example, a carbon dioxide source may also be a CO₂ scrubbing, a CO shift plant, a CO₂-rich fluid, for example a CO₂-rich offgas, or a combination of these.

In a further embodiment of the invention, the chemical plant connected to the mixed gas conduit system is selected from a group of a plant for preparation of methanol, a plant for preparation of higher alcohols, especially ethanol, n-propanol, isopropanol, n-butanol, isobutanol, sec-butanol, tert-butanol, butane-1,4-diol or a combination of these, a plant for preparation of alkanes, especially methane, ethane, propane, n-butane, isobutane, cyclohexane or a combination of these, a plant for preparation of alkenes, especially ethene, propene, but-1-ene, (Z)-but-2-ene, (E)-but-2-ene, 2-methylprop-1-ene, 1,3-butadiene or a combination of these, a plant for preparation of alkynes, especially ethyne, propyne, 1-butyne, 2-butyne or a combination of these, a plant for preparation of ethers, especially linear ethers, cyclic ethers, branched ethers, saturated ethers, unsaturated ethers, dimethyl ether (DME), isopropyl methyl ether, oxacyclohexane, polyoxymethylene dimethyl ether (OME) or a combination of these, a plant for preparation of aldehydes, especially formaldehyde, acetaldehyde, propanal, butanal or a combination of these, a plant for preparation of ketones, especially acetone, butanone, 2-pentanone, 3-pentanone, methyl isopropyl ketone or a combination of these, a plant for preparation of carboxylic acids, especially formic acid, acetic acid, propionic acid, oxalic acid or a combination of these, or a combination of these.

In a further embodiment of the invention, the composition of the furnace gas quantity stream provided in step a) additionally comprises nitrogen.

According to a further embodiment of the invention, the at least one mixed gas produced in step c) is adjusted to a stoichiometric mixing quotient with the dividend with the difference value between the molar amounts of hydrogen as minuend and carbon dioxide as subtrahend and the divisor with the sum value of the molar amounts of carbon monoxide and carbon dioxide in the range from 1 to 10, preferably in the range from 1.2 to 6, more preferably in the range from 1.8 to 4, most preferably in the range from 1.9 to 3.

In a further embodiment of the invention, the plant complex additionally includes at least one plant for gas cleaning, wherein the at least one plant for gas cleaning is connected to the furnace gas conduit system and/or the H₂ gas conduit system and/or the mixed gas conduit system, wherein the method comprises, as a further step e), the cleaning of the at least one furnace gas quantity stream provided in step a) and/or of the hydrogen-containing gas quantity stream provided in step b) and/or of the at least one mixed gas produced in step c).

According to a further embodiment of the invention, the plant complex additionally includes at least one plant for gas compression, wherein the at least one plant for gas compression is connected to the furnace gas conduit system and/or the H₂ gas conduit system and/or the mixed gas conduit system, wherein the method comprises, as a further step f), the compressing of the at least one furnace gas quantity stream provided in step a) and/or of the hydrogen-containing gas quantity stream provided in step b) and/or of the at least one mixed gas produced in step c).

In a further embodiment of the invention, the compressing in step f) is performed at a pressure in the range from 1 to 400 bar, preferably in the range from 20 to 200 bar, more preferably in the range from 50 to 130 bar, most preferably in the range from 60 to 80 bar.

According to a further embodiment of the invention, the plant complex additionally comprises a plant for carbon monoxide separation and/or carbon dioxide separation, wherein the method comprises, as a further step g), the at least partial separating of carbon monoxide and/or carbon dioxide.

According to a further embodiment of the invention, the plant complex additionally comprises a further carbon dioxide source, wherein the method of establishing the stoichiometric mixing quotient of the at least one mixed gas produced comprises, as a further step h), the supplying of carbon dioxide from the further carbon dioxide source.

According to a further embodiment of the invention, the sequence and/or number of steps e) to h) is arbitrary.

Specifically, the invention encompasses the following first preferred embodiments:
1. A first preferred embodiment is a plant complex for pig iron production comprising
   a blast furnace for pig iron production,
   a blast furnace gas conduit system for at least one blast furnace gas quantity stream obtained in the pig iron production, wherein the blast furnace gas quantity stream has a composition comprising at least nitrogen, carbon monoxide and carbon dioxide,
   a hydrogen source,
   an H₂ gas conduit system for at least one hydrogen-containing gas quantity stream emitted from the hydrogen source,
   characterized in that
   at least one mixing apparatus for establishing at least one mixed gas formed from the at least one blast furnace gas stream and the at least one hydrogen-containing gas quantity stream emitted from the hydrogen source is provided, wherein the at least one mixing apparatus is connected to the blast furnace gas conduit system and to the H₂ gas conduit system and wherein the at least one mixed gas established comprises at least a stoichiometric mixing quotient formed from a dividend with the difference value between the molar amounts of hydrogen as minuend and carbon dioxide as subtrahend and of a divisor with the sum value of the molar amounts of carbon monoxide and carbon dioxide, and a mixed gas conduit system for the at least one mixed gas which is obtained in the establishment of the at least one mixing quotient and has a chemical plant connected to the mixed gas conduit system.
2. The plant complex according to the first preferred embodiment 1, characterized in that the mixed gas established with the at least one mixing apparatus has a mixing quotient in the range from 1.2 to 10, preferably in the range from 1.8 to 6, more preferably in the range from 1.9 to 4, most preferably in the range from 2 to 3.
3. The plant complex according to either of the first preferred embodiments 1 and 2, characterized in that the plant complex additionally comprises at least one plant for gas cleaning, wherein the at least one plant for gas cleaning is connected to the blast furnace gas conduit system and/or the H₂ gas conduit system and/or the mixed gas conduit system.
4. The plant complex according to any of the first preferred embodiments 1 to 3, characterized in that the plant complex additionally comprises at least one plant for gas compression, wherein the at least one plant for gas compression is connected to the blast furnace gas conduit system and/or the H₂ gas conduit system and/or the mixed gas conduit system.
5. The plant complex according to any of the first preferred embodiments 1 to 4, characterized in that the plant complex additionally comprises at least one plant for carbon monoxide separation and/or carbon dioxide separation, wherein the at least one plant for carbon monoxide separation and/or carbon dioxide separation is connected to the blast furnace gas conduit system and/or the H₂ gas conduit system and/or the mixed gas conduit system.
6. The plant complex according to any of the first preferred embodiments 1 to 5, characterized in that the plant complex additionally comprises a further carbon dioxide source, wherein the at least one further carbon dioxide source is connected to the blast furnace gas conduit system and/or the H₂ gas conduit system and/or the mixed gas conduit system.
7. The plant complex according to any of the first preferred embodiments 1 to 6, characterized in that the chemical plant connected to the mixed gas conduit system is selected from a group of a plant for preparation of methanol, a plant for preparation of higher alcohols, especially ethanol, n-propanol, isopropanol, n-butanol, isobutanol, sec-butanol, tert-butanol, butane-1,4-diol or a combination of these, a plant for preparation of alkanes, especially methane, ethane, propane, n-butane, isobutane, cyclohexane or a combination of these, a plant for preparation of alkenes, especially ethene, propene, but-1-ene, (Z)-but-2-ene, (E)-but-2-ene, 2-methylprop-1-ene, 1,3-butadiene or a combination of these, a plant for preparation of alkynes, especially ethyne, propyne, 1-butyne, 2-butyne or a combination of these, a plant for preparation of ethers, especially linear ethers, cyclic ethers, branched ethers, saturated ethers, unsaturated ethers, dimethyl ether (DME), isopropyl methyl ether, oxacyclohexane, polyoxymethylene dimethyl ether (OME) or a combination of these, a plant for preparation of aldehydes, especially formaldehyde, acetaldehyde, propanal, butanal or a combination of these, a plant for preparation of ketones, especially acetone, butanone, 2-pentanone, 3-pentanone, methyl isopropyl ketone or a combination of these, a plant for preparation of carboxylic acids, especially formic acid, acetic acid, propionic acid, oxalic acid or a combination of these, or a combination of these.
8. A first preferred embodiment comprises a method of operating a plant complex comprising
   a blast furnace for pig iron production,
   a blast furnace gas conduit system for at least one blast furnace gas quantity stream obtained in the pig iron production, wherein the blast furnace gas quantity stream has a composition comprising at least nitrogen, carbon monoxide and carbon dioxide,
   a hydrogen source,
   an H₂ gas conduit system for at least one hydrogen-containing gas quantity stream emitted from the hydrogen source,
   at least one mixing apparatus for establishing at least one mixed gas formed from the at least one blast furnace gas stream and the at least one hydrogen-containing gas quantity stream emitted from the hydrogen source is provided, wherein the at least one mixing apparatus is connected to the blast furnace gas conduit system and to the H₂ gas conduit system and wherein the at least one mixed gas established comprises at least a stoichiometric mixing quotient formed from a dividend with the difference value between the molar amounts of hydrogen as minuend and carbon dioxide as subtrahend and of a divisor with the sum value of the molar amounts of carbon monoxide and carbon dioxide, and
   a mixed gas conduit system for the at least one mixed gas which is obtained in the establishment of the at least one mixing quotient and has a chemical plant connected to the mixed gas conduit system, comprising the following steps:
      a) providing the at least one blast furnace gas quantity stream;
      b) providing the at least one hydrogen-containing gas quantity stream emitted from the hydrogen source;
      c) producing at least one mixed gas by mixing the at least one blast furnace gas quantity stream provided in step a) with the at least one hydrogen-containing gas quantity stream provided in step b), wherein the at least a stoichiometric mixing quotient is established with the dividend with the difference value between the molar amounts of hydrogen as minuend and carbon dioxide as subtrahend and the divisor with the sum value of the molar amounts of carbon monoxide and carbon dioxide;
      d) feeding the at least one mixed gas produced in step c) through the mixed gas conduit system to the chemical plant connected to the mixed gas system.
9. The method according to the first preferred embodiment 8, characterized in that the at least one mixed gas provided in step c) is adjusted to a stoichiometric mixing quotient with the dividend with the difference value between the molar amounts of hydrogen as minuend and carbon dioxide as subtrahend and the divisor with the sum value of the molar amounts of carbon monoxide and carbon dioxide in the range from 1.2 to 10, preferably in the range from 1.8 to 6, more preferably in the range from 1.9 to 4, most preferably in the range from 2 to 3.
10. The method according to either of the first preferred embodiments 8 and 9, characterized in that the plant complex additionally includes at least one plant for gas cleaning, wherein the at least one plant for gas cleaning is connected to the blast furnace gas conduit system and/or the H₂ gas conduit system and/or the mixed gas conduit system, wherein the method comprises, as a further step e), the cleaning of the at least one blast furnace gas quantity stream provided in step a) and/or of the hydrogen-containing gas quantity stream provided in step b) and/or of the at least one mixed gas produced in step c).
11. The method according to any of the first preferred embodiments 8 to 10, characterized in that the plant complex additionally includes at least one plant for gas compression, wherein the at least one plant for gas compression is connected to the blast furnace gas conduit system and/or the H₂ gas conduit system and/or the mixed gas conduit system, wherein the method comprises, as a further step f), the compressing of the at least one blast furnace gas quantity stream provided in step a) and/or of the hydrogen-containing gas quantity stream provided in step b) and/or of the at least one mixed gas produced in step c).
12. The method according to the first preferred embodiment 11, characterized in that the compressing in step f) is performed at a pressure in the range from 1 to 400 bar, preferably in the range from 20 to 200 bar, more preferably in the range from 50 to 130 bar, most preferably in the range from 60 to 80 bar.
13. The method according to any of the first preferred embodiments 8 to 12, characterized in that the plant complex additionally comprises a plant for carbon monoxide separation and/or carbon dioxide separation, wherein the method comprises, as a further step g), the at least partial separating of carbon monoxide and/or carbon dioxide.
14. The method according to any of the first preferred embodiments 8 to 13, characterized in that the plant complex additionally comprises a further carbon dioxide source, wherein the method of establishing the stoichiometric mixing quotient of the at least one mixed gas produced comprises, as a further step h), the supplying of carbon dioxide from the further carbon dioxide source.
15. The method according to any of the first preferred embodiments 8 to 14, characterized in that the sequence and/or number of steps e) to h) is arbitrary.

Specifically, the invention encompasses the following second preferred embodiments:
1. A second preferred embodiments is a plant complex for pig iron production comprising a melt reduction furnace for pig iron production,
   a melt reduction furnace gas conduit system for at least one melt reduction furnace gas quantity stream obtained in the pig iron production, wherein the melt reduction furnace gas quantity stream has a composition comprising at least carbon monoxide and carbon dioxide,
   a hydrogen source,
   an H₂ gas conduit system for at least one hydrogen-containing gas quantity stream emitted from the hydrogen source,
   characterized in that
   at least one mixing apparatus for establishing at least one mixed gas formed from the at least one melt reduction furnace gas stream and the at least one hydrogen-containing gas quantity stream emitted from the hydrogen source is provided, wherein the at least one mixing apparatus is connected to the melt reduction furnace gas conduit system and to the H₂ gas conduit system and wherein the at least one mixed gas established comprises at least a stoichiometric mixing quotient formed from a dividend with the difference value between the molar amounts of hydrogen as minuend and carbon dioxide as subtrahend and of a divisor with the sum value of the molar amounts of carbon monoxide and carbon dioxide, and a mixed gas conduit system for the at least one mixed gas which is obtained in the establishment of the at least one mixing quotient and has a chemical plant connected to the mixed gas conduit system.
2. The plant complex according to the second preferred embodiment 1, characterized in that the composition of the melt reduction furnace gas quantity stream additionally comprises nitrogen.
3. The plant complex according to either of the second preferred embodiments 1 and 2, characterized in that the mixed gas established with the at least one mixing apparatus has a mixing quotient in the range from 1 to 10, preferably in the range from 1.2 to 6, more preferably in the range from 1.8 to 4, most preferably in the range from 1.9 to 3.
4. The plant complex according to any of the second preferred embodiments 1 to 3, characterized in that the plant complex additionally comprises at least one plant for gas cleaning, wherein the at least one plant for gas cleaning is connected to the melt reduction furnace gas conduit system and/or the H₂ gas conduit system and/or the mixed gas conduit system.
5. The plant complex according to any of the second preferred embodiments 1 to 4, characterized in that the plant complex additionally comprises at least one plant for gas compression, wherein the at least one plant for gas compression is connected to the melt reduction furnace gas conduit system and/or the H₂ gas conduit system and/or the mixed gas conduit system.
6. The plant complex according to any of the second preferred embodiments 1 to 5, characterized in that the plant complex additionally comprises at least one plant for carbon monoxide separation and/or carbon dioxide separation, wherein the at least one plant for carbon monoxide separation and/or carbon dioxide separation is connected to the melt reduction furnace gas conduit system and/or the H₂ gas conduit system and/or the mixed gas conduit system.
7. The plant complex according to any of the second preferred embodiments 1 to 6, characterized in that the plant complex additionally comprises a further carbon dioxide source, wherein the at least one further carbon dioxide source is connected to the melt reduction furnace gas conduit system and/or the H₂ gas conduit system and/or the mixed gas conduit system.
8. The plant complex according to any of the second preferred embodiments 1 to 7, characterized in that the chemical plant connected to the mixed gas conduit system is selected from a group of a plant for preparation of methanol, a plant for preparation of higher alcohols, especially ethanol, n-propanol, isopropanol, n-butanol, isobutanol, sec-butanol, tert-butanol, butane-1,4-diol or a combination of these, a plant for preparation of alkanes, especially methane, ethane, propane, n-butane, isobutane, cyclohexane or a combination of these, a plant for preparation of alkenes, especially ethene, propene, but-1-ene, (Z)-but-2-ene, (E)-but-2-ene, 2-methylprop-1-ene, 1,3-butadiene or a combination of these, a plant for preparation of alkynes, especially ethyne, propyne, 1-butyne, 2-butyne or a combination of these, a plant for preparation of ethers, especially linear ethers, cyclic ethers, branched ethers, saturated ethers, unsaturated ethers, dimethyl ether (DME), isopropyl methyl ether, oxacyclohexane, polyoxymethylene dimethyl ether (OME) or a combination of these, a plant for preparation of aldehydes, especially formaldehyde, acetaldehyde, propanal, butanal or a combination of these, a plant for preparation of ketones, especially acetone, butanone, 2-pentanone, 3-pentanone, methyl isopropyl ketone or a combination of these, a plant for preparation of carboxylic acids, especially formic acid, acetic acid, propionic acid, oxalic acid or a combination of these, or a combination of these.
9. A second preferred embodiment comprises a method of operating a plant complex comprising
   a melt reduction furnace for pig iron production,
   a melt reduction furnace gas conduit system for at least one melt reduction furnace gas quantity stream obtained in the pig iron production, wherein the melt reduction furnace gas quantity stream has a composition comprising at least carbon monoxide and carbon dioxide,
   a hydrogen source,
   an H₂ gas conduit system for at least one hydrogen-containing gas quantity stream emitted from the hydrogen source,
   at least one mixing apparatus for establishing at least one mixed gas formed from the at least one melt reduction furnace gas stream and the at least one hydrogen-containing gas quantity stream emitted from the hydrogen source is provided, wherein the at least one mixing apparatus is connected to the melt reduction furnace gas conduit system and to the H₂ gas conduit system and wherein the at least one mixed gas established comprises at least a stoichiometric mixing quotient formed from a dividend with the difference value between the molar amounts of hydrogen as minuend and carbon dioxide as subtrahend and of a divisor with the sum value of the molar amounts of carbon monoxide and carbon dioxide, and
   a mixed gas conduit system for the at least one mixed gas which is obtained in the establishment of the at least one mixing quotient and has a chemical plant connected to the mixed gas conduit system, comprising the following steps:
      a) providing the at least one melt reduction furnace gas quantity stream;
      b) providing the at least one hydrogen-containing gas quantity stream emitted from the hydrogen source;
      c) producing at least one mixed gas by mixing the at least one melt reduction furnace gas quantity stream provided in step a) with the at least one hydrogen-containing gas quantity stream provided in step b), wherein the at least a stoichiometric mixing quotient is established with the dividend with the difference value between the molar amounts of hydrogen as minuend and carbon dioxide as subtrahend and the divisor with the sum value of the molar amounts of carbon monoxide and carbon dioxide;
      d) feeding the at least one mixed gas produced in step c) through the mixed gas conduit system to the chemical plant connected to the mixed gas system.
10. The method according to the second preferred embodiment 9, characterized in that the composition of the melt reduction furnace gas quantity stream provided in step a) additionally comprises nitrogen.
11. The method according to either of the second preferred embodiments 9 and 10, characterized in that the at least one mixed gas provided in step c) is adjusted to a stoichiometric mixing quotient with the dividend with the difference value between the molar amounts of hydrogen as minuend and carbon dioxide as subtrahend and the divisor with the sum value of the molar amounts of carbon monoxide and carbon dioxide in the range from 1 to 10, preferably in the range from 1.2 to 6, more preferably in the range from 1.8 to 4, most preferably in the range from 1.9 to 3.
12. The method according to any of the second preferred embodiments 9 to 11, characterized in that the plant complex additionally includes at least one plant for gas cleaning, wherein the at least one plant for gas cleaning is connected to the melt reduction furnace gas conduit system and/or the H₂ gas conduit system and/or the mixed gas conduit system, wherein the method comprises, as a further step e), the cleaning of the at least one melt reduction furnace gas quantity stream provided in step a) and/or of the hydrogen-containing gas quantity stream provided in step b) and/or of the at least one mixed gas produced in step c).
13. The method according to any of the second preferred embodiments 9 to 12, characterized in that the plant complex additionally includes at least one plant for gas compression, wherein the at least one plant for gas compression is connected to the melt reduction furnace gas conduit system and/or the H₂ gas conduit system and/or the mixed gas conduit system, wherein the method comprises, as a further step f), the compressing of the at least one melt reduction furnace gas quantity stream provided in step a) and/or of the hydrogen-containing gas quantity stream provided in step b) and/or of the at least one mixed gas produced in step c).
14. The method according to the second preferred embodiment 13, characterized in that the compressing in step f) is performed at a pressure in the range from 1 to 400 bar, preferably in the range from 20 to 200 bar, more preferably in the range from 50 to 130 bar, most preferably in the range from 60 to 80 bar.
15. The method according to any of the second preferred embodiments 9 to 14, characterized in that the plant complex additionally comprises a plant for carbon monoxide separation and/or carbon dioxide separation, wherein the method comprises, as a further step g), the at least partial separating of carbon monoxide and/or carbon dioxide.
16. The method according to any of the second preferred embodiments 9 to 15, characterized in that the plant complex additionally comprises a further carbon dioxide source, wherein the method of establishing the stoichiometric mixing quotient of the at least one mixed gas produced comprises, as a further step h), the supplying of carbon dioxide from the further carbon dioxide source.
17. The method according to any of the second preferred embodiments 9 to 16, characterized in that the sequence and/or number of steps e) to h) is arbitrary.

Specifically, the invention encompasses the following third preferred embodiments:
1. A third preferred embodiments is a plant complex for pig iron production comprising a direct reduction furnace for pig iron production,
   a direct reduction furnace gas conduit system for at least one direct reduction furnace gas quantity stream obtained in the pig iron production, wherein the direct reduction furnace gas quantity stream has a composition comprising at least carbon monoxide and carbon dioxide,
   a hydrogen source,
   an H₂ gas conduit system for at least one hydrogen-containing gas quantity stream emitted from the hydrogen source,
   characterized in that
   at least one mixing apparatus for establishing at least one mixed gas formed from the at least one direct reduction furnace gas stream and the at least one hydrogen-containing gas quantity stream emitted from the hydrogen source is provided, wherein the at least one mixing apparatus is connected to the direct reduction furnace gas conduit system and to the H₂ gas conduit system and wherein the at least one mixed gas established comprises at least a stoichiometric mixing quotient formed from a dividend with the difference value between the molar amounts of hydrogen as minuend and carbon dioxide as subtrahend and of a divisor with the sum value of the molar amounts of carbon monoxide and carbon dioxide, and a mixed gas conduit system for the at least one mixed gas which is obtained in the establishment of the at least one mixing quotient and has a chemical plant connected to the mixed gas conduit system.
2. The plant complex according to the third preferred embodiment 1, characterized in that the composition of the direct reduction furnace gas quantity stream additionally comprises nitrogen.
3. The plant complex according to either of the third preferred embodiments 1 and 2, characterized in that the mixed gas established with the at least one mixing apparatus has a mixing quotient in the range from 1 to 10, preferably in the range from 1.2 to 6, more preferably in the range from 1.8 to 4, most preferably in the range from 1.9 to 3.
4. The plant complex according to any of the third preferred embodiments 1 to 3, characterized in that the plant complex additionally comprises at least one plant for gas cleaning, wherein the at least one plant for gas cleaning is connected to the direct reduction furnace gas conduit system and/or the H₂ gas conduit system and/or the mixed gas conduit system.
5. The plant complex according to any of the third preferred embodiments 1 to 4, characterized in that the plant complex additionally comprises at least one plant for gas compression, wherein the at least one plant for gas compression is connected to the direct reduction furnace gas conduit system and/or the H₂ gas conduit system and/or the mixed gas conduit system.
6. The plant complex according to any of the third preferred embodiments 1 to 5, characterized in that the plant complex additionally comprises at least one plant for carbon monoxide separation and/or carbon dioxide separation, wherein the at least one plant for carbon monoxide separation and/or carbon dioxide separation is connected to the direct reduction furnace gas conduit system and/or the H₂ gas conduit system and/or the mixed gas conduit system.
7. The plant complex according to any of the third preferred embodiments 1 to 6, characterized in that the plant complex additionally comprises a further carbon dioxide source, wherein the at least one further carbon dioxide source is connected to the direct reduction furnace gas conduit system and/or the H₂ gas conduit system and/or the mixed gas conduit system.
8. The plant complex according to any of the third preferred embodiments 1 to 7, characterized in that the chemical plant connected to the mixed gas conduit system is selected from a group of a plant for preparation of methanol, a plant for preparation of higher alcohols, especially ethanol, n-propanol, isopropanol, n-butanol, isobutanol, sec-butanol, tert-butanol, butane-1,4-diol or a combination of these, a plant for preparation of alkanes, especially methane, ethane, propane, n-butane, isobutane, cyclohexane or a combination of these, a plant for preparation of alkenes, especially ethene, propene, but-1-ene, (Z)-but-2-ene, (E)-but-2-ene, 2-methylprop-1-ene, 1,3-butadiene or a combination of these, a plant for preparation of alkynes, especially ethyne, propyne, 1-butyne, 2-butyne or a combination of these, a plant for preparation of ethers, especially linear ethers, cyclic ethers, branched ethers, saturated ethers, unsaturated ethers, dimethyl ether (DME), isopropyl methyl ether, oxacyclohexane, polyoxymethylene dimethyl ether (OME) or a combination of these, a plant for preparation of aldehydes, especially formaldehyde, acetaldehyde, propanal, butanal or a combination of these, a plant for preparation of ketones, especially acetone, butanone, 2-pentanone, 3-pentanone, methyl isopropyl ketone or a combination of these, a plant for preparation of carboxylic acids, especially formic acid, acetic acid, propionic acid, oxalic acid or a combination of these, or a combination of these.
9. A third preferred embodiment comprises a method of operating a plant complex comprising a direct reduction furnace for pig iron production,
   a direct reduction furnace gas conduit system for at least one direct reduction furnace gas quantity stream obtained in the pig iron production, wherein the direct reduction furnace gas quantity stream has a composition comprising at least carbon monoxide and carbon dioxide,
   a hydrogen source,
   an H₂ gas conduit system for at least one hydrogen-containing gas quantity stream emitted from the hydrogen source (3),
   at least one mixing apparatus for establishing at least one mixed gas formed from the at least one direct reduction furnace gas stream and the at least one hydrogen-containing gas quantity stream emitted from the hydrogen source is provided, wherein the at least one mixing apparatus is connected to the direct reduction furnace gas conduit system and to the H₂ gas conduit system and wherein the at least one mixed gas established comprises at least a stoichiometric mixing quotient formed from a dividend with the difference value between the molar amounts of hydrogen as minuend and carbon dioxide as subtrahend and of a divisor with the sum value of the molar amounts of carbon monoxide and carbon dioxide, and
   a mixed gas conduit system for the at least one mixed gas which is obtained in the establishment of the at least one mixing quotient and has a chemical plant connected to the mixed gas conduit system, comprising the following steps:
      a) providing the at least one direct reduction furnace gas quantity stream;
      b) providing the at least one hydrogen-containing gas quantity stream emitted from the hydrogen source;
      c) producing at least one mixed gas by mixing the at least one direct reduction furnace gas quantity stream provided in step a) with the at least one hydrogen-containing gas quantity stream provided in step b), wherein the at least a stoichiometric mixing quotient is established with the dividend with the difference value between the molar amounts of hydrogen as minuend and carbon dioxide as subtrahend and the divisor with the sum value of the molar amounts of carbon monoxide and carbon dioxide;
      d) feeding the at least one mixed gas produced in step c) through the mixed gas conduit system to the chemical plant connected to the mixed gas system.

10. The method according to the third preferred embodiment 9, characterized in that the composition of the direct reduction furnace gas quantity stream provided in step a) additionally comprises nitrogen.
11. The method according to any of the third preferred embodiments 8 to 10, characterized in that the at least one mixed gas provided in step c) is adjusted to a stoichiometric mixing quotient with the dividend with the difference value between the molar amounts of hydrogen as minuend and carbon dioxide as subtrahend and the divisor with the sum value of the molar amounts of carbon monoxide and carbon dioxide in the range from 1 to 10, preferably in the range from 1.2 to 6, more preferably in the range from 1.8 to 4, most preferably in the range from 1.9 to 3.
12. The method according to any of the third preferred embodiments 9 to 11, characterized in that the plant complex additionally includes at least one plant for gas cleaning, wherein the at least one plant for gas cleaning is connected to the direct reduction furnace gas conduit system and/or the H₂ gas conduit system and/or the mixed gas conduit system, wherein the method comprises, as a further step e), the cleaning of the at least one direct reduction furnace gas quantity stream provided in step a) and/or of the hydrogen-containing gas quantity stream provided in step b) and/or of the at least one mixed gas produced in step c).
13. The method according to any of the third preferred embodiments 9 to 12, characterized in that the plant complex additionally includes at least one plant for gas compression, wherein the at least one plant for gas compression is connected to the direct reduction furnace gas conduit system and/or the H₂ gas conduit system and/or the mixed gas conduit system, wherein the method comprises, as a further step f), the compressing of the at least one direct reduction furnace gas quantity stream provided in step a) and/or of the hydrogen-containing gas quantity stream provided in step b) and/or of the at least one mixed gas produced in step c).
14. The method according to the third preferred embodiment 13, characterized in that the compressing in step f) is performed at a pressure in the range from 1 to 400 bar, preferably in the range from 20 to 200 bar, more preferably in the range from 50 to 130 bar, most preferably in the range from 60 to 80 bar.
15. The method according to any of the third preferred embodiments 9 to 14, characterized in that the plant complex additionally comprises a plant for carbon monoxide separation and/or carbon dioxide separation, wherein the method comprises, as a further step g), the at least partial separating of carbon monoxide and/or carbon dioxide.
16. The method according to any of the third preferred embodiments 9 to 15, characterized in that the plant complex additionally comprises a further carbon dioxide source, wherein the method of establishing the stoichiometric mixing quotient of the at least one mixed gas produced comprises, as a further step h), the supplying of carbon dioxide from the further carbon dioxide source.
17. The method according to any of the third preferred embodiments 9 to 16, characterized in that the sequence and/or number of steps e) to h) is arbitrary.

### BRIEF DESCRIPTION OF THE DRAWINGS

The invention is elucidated briefly hereinafter by a drawing that shows just one working example. The FIGURE shows, in schematic form,

FIG. 1 a highly simplified block diagram of a plant complex of the invention for pig iron production.

FIG. 1, according to one embodiment of the invention, a plant complex for pig iron production comprising a furnace 1 for pig iron production, a furnace gas conduit system 2 for at least one furnace gas quantity stream obtained in the pig iron production, a hydrogen source 3, an H₂ gas conduit system 4 for at least one hydrogen-containing gas quantity stream emitted from the hydrogen source 3, a mixing apparatus 5 for establishing at least one mixed gas formed from the at least one furnace gas stream and the at least one hydrogen-containing gas quantity stream emitted from the hydrogen source 3, wherein the at least one mixing apparatus 5 is connected to the furnace gas conduit system 2 and to the H₂ gas conduit system 4, and a mixed gas conduit system 6 for the at least one mixed gas which is supplied after establishment of an at least one mixing quotient in a chemical plant 7 connected to the mixed gas conduit system 6. Optional plants in the plant complex of the invention are shown by dotted lines. Optionally arranged here in the furnace gas conduit system 2 are a plant for gas cleaning 8, a plant for carbon monoxide separation 10, a plant for carbon dioxide separation 11, and/or a further carbon dioxide source 12 is additionally supplied. Optionally disposed in the mixed gas conduit system 6 is a plant for gas compression 9. The number and/or sequence of the arrangement of all the aforementioned apparatuses is arbitrary, provided that the establishment of a mixed gas comprising furnace gas and hydrogen-containing gas in a mixing apparatus and the supply of the mixed gas established into a chemical plant is included. Only the main flows are shown as flow arrows in FIG. 1.

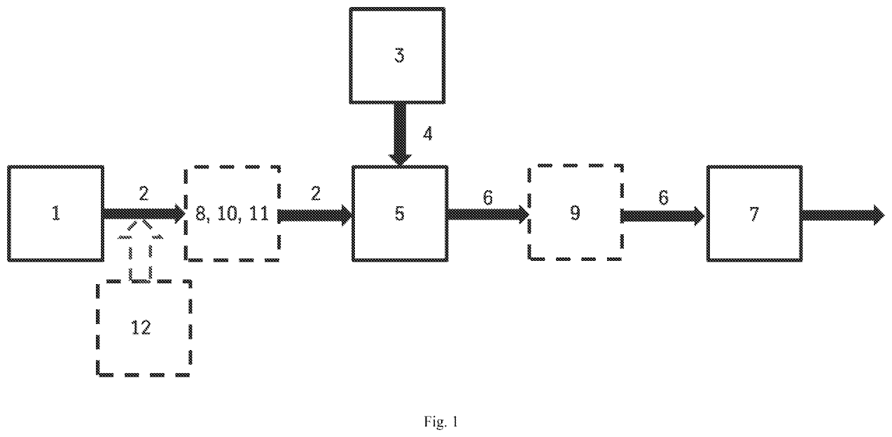

### INDUSTRIAL APPLICABILITY

A plant complex for pig iron production and a method of operating a plant complex of the type described above may be used in the production of pig iron.

### LIST OF REFERENCE NUMERALS

1=furnace, especially blast furnace, melt reduction furnace, direct reduction furnace
2=furnace gas conduit system, especially blast furnace gas conduit system, melt reduction furnace gas conduit system, direct reduction furnace gas conduit system
3=hydrogen source
4=H₂ gas conduit system
5=mixing apparatus
6=mixed gas conduit system
7=chemical plant
8=plant for gas cleaning
9=plant for gas compression
10=plant for carbon monoxide separation
11=plant for carbon dioxide separation
12=carbon dioxide source

1.-17. (canceled)

18. A plant complex for pig iron production, the plant comprising:
a furnace for pig iron production;
a furnace gas conduit system for a furnace gas quantity stream obtained in the pig iron production, wherein the furnace gas quantity stream comprises carbon monoxide and carbon dioxide;
a hydrogen source;
an H₂ gas conduit system for a hydrogen-containing gas quantity stream emitted from the hydrogen source;
a mixing apparatus for establishing a mixed gas formed from the furnace gas quantity stream and the hydrogen-containing gas quantity stream, wherein the mixing apparatus is connected to the furnace gas conduit system and to the H₂ gas conduit system, wherein the mixed gas comprises a stoichiometric mixing quotient formed from a dividend with a difference value between molar amounts of hydrogen as minuend and carbon dioxide as subtrahend and of a divisor with a sum value of molar amounts of carbon monoxide and carbon dioxide;
a mixed gas conduit system for the mixed gas that is obtained in establishing the stoichiometric mixing quotient; and
a chemical plant connected to the mixed gas conduit system.

19. The plant complex of claim 18 wherein the furnace gas quantity stream comprises nitrogen.

20. The plant complex of claim 18 wherein the mixed gas has a mixing quotient in a range from 1 to 10.

21. The plant complex of claim 18 comprising a plant for gas cleaning, wherein the plant for gas cleaning is connected to at least one of the furnace gas conduit system, the H₂ gas conduit system, or the mixed gas conduit system.

22. The plant complex of claim 18 comprising a plant for gas compression, wherein the plant for gas compression is connected to at least one of the furnace gas conduit system, the H₂ gas conduit system, or the mixed gas conduit system.

23. The plant complex of claim 18 comprising a plant that is for at least one of carbon monoxide separation or carbon dioxide separation and is connected to at least one of the furnace gas conduit system, the H₂ gas conduit system, or the mixed gas conduit system.

24. The plant complex of claim 18 comprising a carbon dioxide source that is connected to at least one of the furnace gas conduit system, the H₂ gas conduit system, or the mixed gas conduit system.

25. The plant complex of claim 18 wherein the chemical plant is at least one of:
a plant for preparation of methanol;
a plant for preparation of alkanes;
a plant for preparation of alkenes;
a plant for preparation of alkynes;
a plant for preparation of ethers;
a plant for preparation of aldehydes;
a plant for preparation of ketones; or
a plant for preparation of carboxylic acids.

26. The plant complex of claim 18 wherein the chemical plant is at least one of:
a plant for preparation of ethanol, n-propanol, isopropanol, n-butanol, isobutanol, sec-butanol, tert-butanol, butane-1,4-diol, or a combination thereof;
a plant for preparation of methane, ethane, propane, n-butane, isobutane, cyclohexane, or a combination thereof;
a plant for preparation of ethene, propene, but-1-ene, (Z)-but-2-ene, (E)-but-2-ene, 2-methylprop-1-ene, 1,3-butadiene, or a combination thereof;
a plant for preparation of ethyne, propyne, 1-butyne, 2-butyne, or a combination thereof;
a plant for preparation of linear ethers, cyclic ethers, branched ethers, saturated ethers, unsaturated ethers, dimethyl ether (DME), isopropyl methyl ether, oxacyclohexane, polyoxymethylene dimethyl ether (OME), or a combination thereof;
a plant for preparation of formaldehyde, acetaldehyde, propanal, butanal, or a combination thereof;
a plant for preparation of acetone, butanone, 2-pentanone, 3-pentanone, methyl isopropyl ketone, or a combination thereof; or
a plant for preparation of formic acid, acetic acid, propionic acid, oxalic acid, or a combination thereof.

27. A method of operating the plant complex of claim 18, the method comprising:
providing the furnace gas quantity stream;
providing the hydrogen-containing gas quantity stream emitted from the hydrogen source;
producing the mixed gas by mixing the furnace gas quantity stream with the hydrogen-containing gas quantity stream, wherein the stoichiometric mixing quotient is established with the dividend with the difference value between the molar amounts of hydrogen as the minuend and carbon dioxide as the subtrahend and of the divisor with the sum value of the molar amounts of carbon monoxide and carbon dioxide; and
feeding the mixed gas through the mixed gas conduit system to the chemical plant connected to the mixed gas stream.

28. A method of producing pig iron in a plant complex, the method comprising:
providing a furnace gas quantity stream;
providing a hydrogen-containing gas quantity stream emitted from a hydrogen source;
producing a mixed gas by mixing the furnace gas quantity stream with the hydrogen-containing gas quantity stream, wherein a stoichiometric mixing quotient is established with a dividend with a difference value between molar amounts of hydrogen as a minuend and carbon dioxide as a subtrahend and of a divisor with a sum value of molar amounts of carbon monoxide and carbon dioxide; and
feeding the mixed gas through a mixed gas conduit system to a chemical plant connected to the mixed gas stream.

29. The method of claim 28 wherein the furnace gas quantity stream comprises nitrogen.

30. The method of claim 28 comprising adjusting the mixed gas to a stoichiometric mixing quotient with a dividend with a difference value between molar amounts of hydrogen as minuend and carbon dioxide as subtrahend and a divisor with a sum value of molar amounts of carbon monoxide and carbon dioxide in a range from 1.2 to 10.

31. The method of claim 28 comprising cleaning at least one of the furnace gas quantity stream, the hydrogen-containing gas quantity stream, or the mixed gas.

32. The method of claim 28 comprising compressing at least one of the furnace gas quantity stream, the hydrogen-containing gas quantity stream, or the mixed gas.

33. The method of claim 32 wherein the compressing is performed at a pressure in a range from 1 to 400 bar.

34. The method of claim 28 comprising at least partially separating carbon monoxide and/or carbon dioxide.

35. The method of claim 28 wherein establishing the stoichiometric mixing quotient of the mixed gas comprises supplying carbon dioxide from a carbon dioxide source.
